(19) United States
(12) Patent Application Publication
(10) Pub. No.: US 2007/0000255 A1
(43) Pub. Date: Jan. 4, 2007

(54) Autonomous air-conditioning module intended particularly for the thermal treatment of an area of a vehicle cabin

(75) Inventors: Gilles Elliot, Courcouronnes (FR); Vincent Feuillard, Le Mesnil St Denis (FR); David Roy, Paris (FR)

Correspondence Address: Valeo Climate Control Corp.;Intellectual Property Dept., 4100 North Atlantic Boulevard, Auburn Hills, MI, 48326, US

(73) Assignee: Valeo Systemes Thermiques S.A.S., Le Mesnil St Denis (FR)

(21) Appl. No.: 11/435,802

(22) Filed: May 17, 2006

(30) Foreign Application Priority Data
May 27, 2005 (FR) 05 05337

(51) Int. Cl. F25B 21/02; B60H 1/32

(52) U.S. Cl. 62/3.5; 62/244

(57) ABSTRACT

The subject of the invention is a module for ventilating, heating and/or air-conditioning an area (5) of a vehicle cabin (1) that is to be thermally treated. This module (2) comprises a thermal treatment device (7) which includes an enclosure (38) and an impeller (12) and is designed to extract air from the cabin (1), circulate this air inside the enclosure (38) and expel the air toward the area (5) to be treated. A Peltier-type cell (18) is housed inside the enclosure (38), the latter comprising a first duct (16) for circulating the admitted air along the first face (21) of the Peltier cell (18), prior to its being expelled toward the area (5) to be treated, and a second duct (17) for circulating the admitted air along the second face (22) of the Peltier cell (18), prior to its being expelled from the area (5) to be treated.

### TECHNICAL FIELD OF THE INVENTION

The present invention belongs to the field of ventilating, heating and/or air-conditioning installations, in particular for a vehicle cabin. The subject of the invention is an autonomous ventilating, heating and/or air-conditioning module intended for the thermal treatment of a specific area of the cabin, such as the rear area thereof.

### PRIOR ART

It is known practice to make use of a main ventilating, heating and/or air-conditioning installation for thermally treating the rear area of a vehicle cabin. Since the main installation is situated at the front of the vehicle, it is conventional to convey the air treated by the main installation toward the rear area of the cabin by means of a specific duct. A drawback of organizing the thermal treatment of the rear area in such a way is constituted by the airflow losses and thermal losses occasioned as the air is being conveyed through the duct. This results in reduced efficiency of the thermal treatment of the rear cabin area. Moreover, the overall size of the duct requires a specific layout for routing said duct from the front to the rear of the cabin. Finally, the thermal treatment of the rear cabin area is dependent on that of the front area.

To counter these drawbacks, it has been proposed to organize the thermal treatment of the rear cabin area of the vehicle on the basis of a specific secondary ventilating, heating and/or air-conditioning installation, placed for example between the rear seats or even in the vehicle trunk. Such an organization leads to an overall size and costs which it is desirable to reduce. Moreover, the secondary installation comprises an air-conditioning loop inside which a heat-transfer fluid circulates, it being sought to reduce the quantity thereof required per vehicle in order to reduce the costs relating to the ventilation of the vehicle and to minimize the risks of the heat-transfer fluid leaking inside the cabin.

It has therefore been proposed to thermally treat the rear cabin area of the vehicle by using at least one autonomous ventilating, heating and/or air-conditioning module comprising an impeller and at least one Peltier-type cell supplied with electrical energy by a polarized power source.

For example, document FR2843446 (PEUGEOT CITROEN AUTOMOBILES SA) proposes employing a thermal treatment module which makes use of a Peltier cell, one of its faces being exploited for the thermal treatment of the area to be treated. This Peltier cell is in contact with a thermal regulation loop, inside which a heat-transfer fluid circulates, and a thermal extractor, such as a nozzle or a radiator.

Again, for example, document WO9910191 (PROTASIEWYTCH ELOIR FERNANDO) proposes employing a thermal treatment module which makes use of a Peltier cell, one of its faces being exploited for the thermal treatment of the area to be treated. This Peltier cell is in contact with a thermal regulation loop equipped with a pump for promoting the circulation of the heat-transfer fluid.

The drawback of such modules is that they have a large number of components which give rise to an excessive overall size and to excessive costs. Furthermore, these components consume a quantity of energy which it is desirable to minimize. Finally, the general organization of these components among one another proves to be complex for a module that is desired to be compact, lightweight and easy to install in the cabin.

### AIM OF THE INVENTION

The object of the present invention is to provide a ventilating, heating and/or air-conditioning module which overcomes the aforementioned drawbacks. More specifically, the present invention aims to provide such a module whose general organization is simple and which has the lowest possible number of components with a small overall size, and whose installation is easy with regard to the space available in the vehicle cabin. The invention also aims to provide such a module whose dependence on the use of other vehicle equipment is as small as possible. The invention additionally aims to provide such a module in which the supply of electrical energy and the control of its operation are as simple and efficient as possible. Finally, the invention aims to provide such a module which is able to thermally treat specific cabin areas independently by selecting a choice of module operating mode in a simple manner.

The module of the present invention is a module for ventilating, heating and/or air-conditioning an area of a vehicle cabin that is to be thermally treated. This module comprises at least one thermal treatment device which includes an enclosure in contact with at least one impeller and is designed to extract air from the cabin and circulate this air inside the enclosure and then to expel the air toward the area to be treated.

According to the present invention, at least one Peltier-type cell is housed inside the enclosure, the latter comprising a first duct for circulating the admitted air along a first face of the Peltier cell, prior to its being expelled toward the area to be treated, and a second duct for circulating the admitted air along a second face of the Peltier cell, prior to its being expelled from the area to be treated, and in particular from the vehicle cabin.

More specifically, the cell is of the type having two opposed faces which behave thermally in a reverse manner, one being endothermic, the other exothermic. Advantageously, by reversing the polarity of the power source, the thermal behavior of its faces is reversed. The impeller extracts air from the cabin, a fraction of this air being directed toward one face of the Peltier cell, in contact with which the air experiences a heat exchange. Since this face is either endothermic or exothermic depending on the polarity imposed by the electrical power supply of the Peltier cell, it is possible to cool or heat the extracted air which circulates along this face and then expel it toward the area to be treated. The other fraction of air extracted from the cabin by the impeller is used to oppose a temperature variation of the second face of the Peltier cell, this air fraction then being expelled from the area to be treated, preferably from the vehicle cabin.

Said device is advantageously equipped with means for controlling the temperature of the Peltier cell and the air delivery rate of the impeller.

The control means are preferably borne by an electronic card. According to a first variant embodiment, the electronic card is placed inside said first duct. According to a second variant embodiment, the electronic card is placed inside said second duct, in particular upstream of the second face of the Peltier cell with respect to the airflow circulating inside said second duct.

The device is advantageously housed inside a casing equipped with means for fastening it to a structural element of the cabin. This structural element may equally be the roof or the floor, or even a door of the vehicle, a seat or a headrest, for example. According to a first embodiment of the means for fastening the casing, these are means for fastening the casing to a rail of the vehicle roof, this rail more specifically being arranged under the roof inside the cabin. According to a second embodiment of the means for fastening the casing, these are means for embedding the casing in the headliner of the vehicle.

The casing advantageously houses the impeller in a first chamber, which is in communication with the enclosure formed by a second chamber of the casing.

The casing advantageously comprises at least one air intake orifice in contact with the air inlet of the impeller and at least two air outlet orifices for expelling air from the casing, a first air outlet orifice of which is in communication with the first duct and a second air outlet orifice of which is in communication with the second duct.

The air intake orifice is preferably formed through at least any one of the walls of the casing, such as a bottom wall, a top wall or a lateral wall of the casing.

The first air outlet orifice is preferably formed through at least any one of the walls of the casing, such as a bottom wall of the casing or a lateral wall of the casing.

Preferably, the first air outlet orifice is equipped with at least one air vent. According to another embodiment of the air vent, the latter is configured as a retractable and/or fixed and/or multi-directional cage, such as a cage mounted in a pivoting or tilting manner on the casing.

The second air outlet orifice is preferably formed through at least one wall of the casing, such as a rear wall thereof. According to a preferred embodiment, the second air outlet orifice is formed in an upper wall of the casing such that the air is expelled to the outside of the cabin via the vehicle roof. According to a first variant embodiment, the second air outlet orifice is in contact with an additional duct conveying the air to the outside of the cabin. According to a second variant embodiment, the second air outlet orifice is in contact with an air passage formed between the headliner and the roof of the vehicle. In this case, the casing is able to be directly affixed to the headliner of the vehicle, such that its upper face is in communication with said air passage. It should be noted that in the case where the casing is affixed to the headliner of the vehicle, the whole of its upper face is able to be open, the headliner forming a closure cap for this upper face.

The activation of the control means is advantageously placed under the control of operating means. These operating means are preferably borne by the casing, for example by a lower wall of the casing, this wall likewise bearing the electronic card.

Preferably, the operating means additionally comprise remote-control operating means, of the infrared, high-frequency or similar type.

The operating means advantageously comprise means for selecting the thermal behavior of the faces of the Peltier cell. For example, the selection means are associated with means for reversing the polarity of at least one electrical power supply source of the Peltier cells. Given a plurality of Peltier cells, the selection means can be associated with means for selective operation between a first, series wiring of the Peltier cells and a second, parallel wiring of these cells.

The impeller may equally be a single-suction impeller or a double-suction impeller.

One of the faces of the Peltier-type cell is advantageously equipped with an element for dissipating thermal energy.

According to a preferred variant embodiment of the present invention, the module comprises two thermal treatment devices intended for independently treating a respective area of the cabin. In this case, the casing preferably houses said thermal treatment devices adjacently.

### DESCRIPTION OF THE FIGURES

The present invention will be better understood, and details pertaining thereto will become apparent, on reading the description which will be given thereof with reference to the figures of the appended plates, in which:

FIG. 1 is a schematic sectional view of a vehicle cabin equipped with two ventilating, heating and/or air-conditioning modules according to the invention.

FIG. 2 and FIG. 3 are diagrams illustrating respective embodiments for expelling air from a module of the invention to the outside of the vehicle.

FIG. 4 and FIG. 5 are schematic sectional views of respective embodiments of one of the modules represented in FIG. 1.

FIG. 6 and FIG. 7 are respective schematic views of wiring modes for the Peltier cells belonging to the modules illustrated in FIG. 4 and FIG. 5.

FIG. 8 to FIG. 12 are schematic sectional views of Peltier cells equipping a module of the invention, which are equipped with heat sinks.

FIG. 13 is a schematic perspective view of a variant embodiment of a module represented in FIG. 1 and FIG. 2.

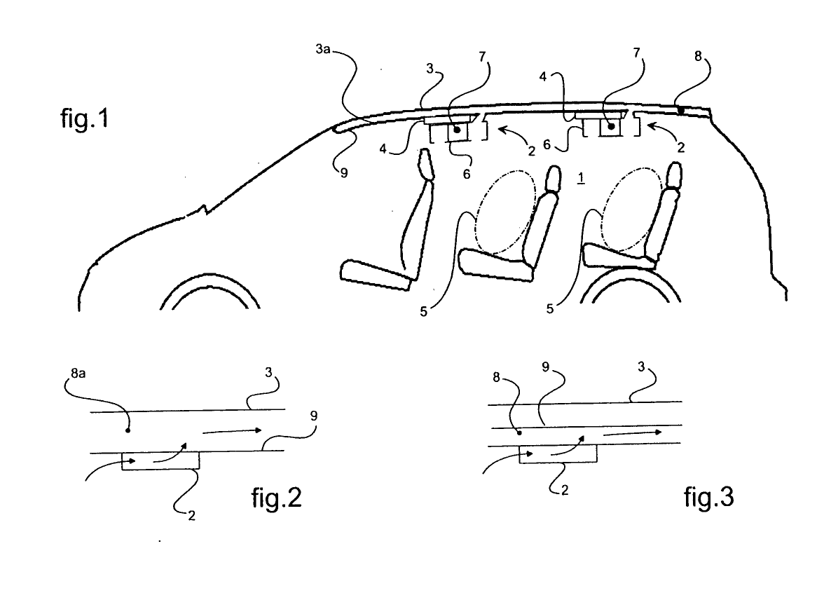

In FIG. 1, the cabin (1) of a vehicle is equipped with two autonomous ventilating, heating and/or air-conditioning modules (2) which are fastened to the headliner (9) of the vehicle roof (3). This fastening is achieved for example by means of fastening rails (4) inside the vehicle cabin (1) or by embedding the modules inside housings formed in the headliner (9). According to variant embodiments (not shown), the module (2) can be fastened to another structural element of the vehicle cabin (1), such as the floor or a door, or else a seat or a headrest. Generally, the module may be fastened to any structural element of the vehicle and/or of its cabin, preferably close to the area (5) to be treated.

Each module (2) is intended for thermally treating a specific area (5) of the cabin (1), such as, according to the example illustrated, one of the rear seat rows of a vehicle of the minivan type, with the aim of independently improving the thermal comfort of the passengers occupying these areas (5). The areas (5) of the vehicle that are to be treated are particularly areas which are occupied or can be occupied by at least one passenger and which are surrounded by a volume of air to be treated thermally.

Each module (2) comprises a casing (6) which houses a thermal treatment device (7) intended to extract air from the cabin (1), to cool and/or heat a portion of the extracted air before expelling it toward an area (5) to be treated, and, conversely, to heat and/or cool the other portion of the extracted air before expelling it to the outside of the cabin (1), or at the very least beyond the area (5) to be treated.

In FIG. 2 and FIG. 3, a module (2) is fastened to the headliner (9) of the vehicle. Depending on the configuration of the vehicle, the space contained between the roof (3) and the headliner (9) when sufficient is exploited to convey air to the outside of the cabin (1), as represented in FIG. 2. Where this space is not sufficient, an additional duct (39) is connected to the module to expel the air, as represented in FIG. 3.

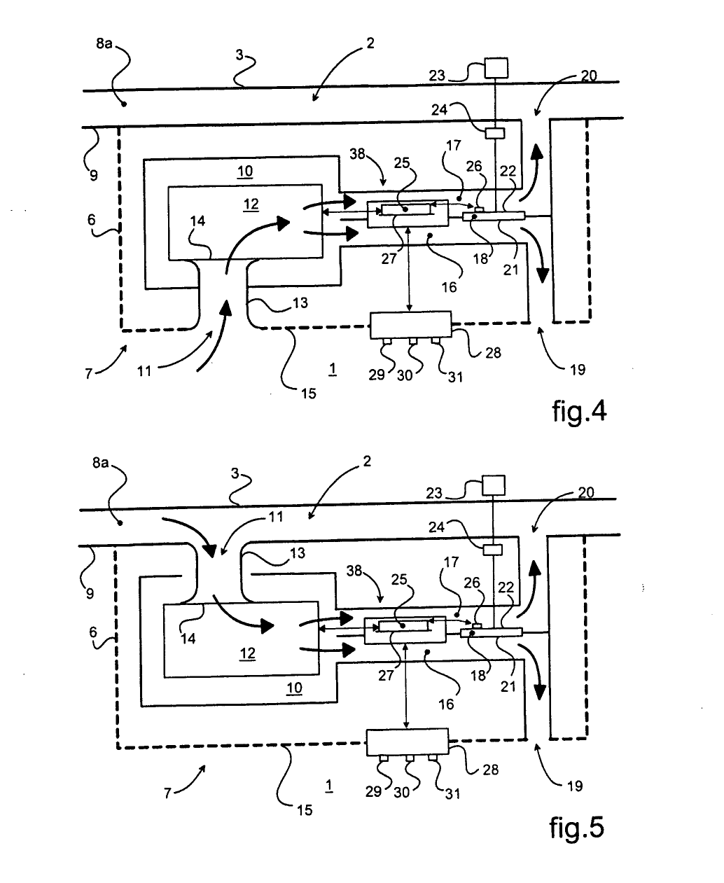

In FIG. 4 and FIG. 5, the casing (6) comprises a first chamber (10) in communication with the vehicle cabin (1) via an air intake orifice (11) formed in a wall of the casing (6). In the variant represented in FIG. 4, this wall is a lower wall (15) of the casing, the air being extracted from inside the cabin (1). In the variant represented in FIG. 5, this wall is the upper wall (40) of the casing (6), the air being extracted from the cabin (1) inside the space contained between the roof (3) and the headliner (9) so as to limit the noise which is generated by the impeller and which is liable to be a source of discomfort for the passengers.

The air is admitted to the inside of the first chamber (10) by means of an impeller (12) housed in this chamber (10). The impeller (12) may equally be a single-suction or double-suction impeller. In the case of a single-suction impeller, as illustrated in FIG. 4 and FIG. 5, a suction shroud (13) can be interposed between the air intake orifice (11) and the air inlet (14) of the impeller (12). Various layout configurations for the air intake orifice (11) of the first chamber (10) and of the air inlet (14) of the impeller (12) are possible. For example, in FIG. 4 and FIG. 5, said orifice (11) and said inlet (14) are opposite one another so as to promote the intake of air into the first chamber (10).

The first chamber (10) is in communication with a second chamber of the casing (6), forming a heat-exchange enclosure (38) between the extracted air and a Peltier-type cell (18). The enclosure (38) is mainly composed of two air circulation ducts (16, 17), each of these ducts (16, 17) being in contact with the first chamber (10). A first duct (16) is in contact with a first air outlet orifice (19) for expelling air toward the area (5) to be treated and a second duct (17) is in contact with a second outlet orifice (20) for expelling air from the area (5) to be treated.

The Peltier cell (18) is housed in the enclosure (38) in an intermediate position between the first duct (16) and the second duct (17) such that a first face (21) of the cell (18) is in contact with the air circulating in the first duct (16), while the other face (22) of the cell (18) is in contact with the air circulating in the second duct (17). The Peltier cell (18) is supplied with electrical energy by a polarized power supply source (23), in particular the vehicle battery, via an electrical connection (24) provided in the casing (6). The module (2) is advantageously connected to the polarized power supply source (23) at the same time as the casing (6) is fastened to the structural element (3) of the vehicle.

Since one of the faces (21, 22) of the Peltier cell is endothermic and the other face is exothermic, it is possible to cool the air circulating in one of the ducts (16, 17), for example the first duct (16), and to heat the air circulating in the other duct, that is to say the second duct (17) in the example chosen. The air cooled in the first duct (16) is expelled toward the area (5) to be treated through the first outlet orifice (19), while the air heated in the second duct (17) is expelled from the area (5) to be treated through the second outlet orifice (20). This example of operation will be employed in particular during the summer period to cool the air of the area (5) to be treated. By reversing the polarity of the power supply source (23), it is possible to invert the thermal behavior of the faces (21, 22) of the Peltier cell (18) in order to heat the air circulating in the first duct (16) and cool the air circulating in the second duct (17). The air cooled in the second duct (17) is then expelled from the area (5) to be treated through the second outlet orifice (20), while the air heated in the first duct (16) for its part is expelled toward the area (5) to be treated through the first outlet orifice (19). This example of operation will be employed in particular in the winter period in order to heat the air of the area (5) to be treated.

Reversing the polarity of the electrical supply of the Peltier cell (18) is brought about particularly on the command of a passenger, depending on whether he wishes to be supplied with cold or hot air. The thermal treatment device (7) is equipped with means (25) for controlling the temperature of the Peltier cell (18) and the air delivery rate of the impeller (12). These means (25) comprise for example a temperature sensor (26) placed on one of the faces of the Peltier cell (18) and/or in the corresponding air circulation duct. According to an alternative embodiment, two temperature sensors are respectively placed on each of the faces of the cell and/or in the corresponding air circulation ducts. The control means (25) are borne by an electronic card (27) placed in the second air circulation duct (17) for expelling heat from the area (5) to be treated that has been induced by the electronic components borne by said card (27). The control means (25, 26) are placed under the control of operating means (28) comprising selection elements (29, 30, 31), such as push buttons or turn buttons, in order to respectively determine the operating temperature of the Peltier cell (18) and the air delivery rate of the impeller (12). For example, the operating means (28) comprise an element (31) for selecting between a winter operating mode and a summer operating mode of the thermal treatment device (2), in order to determine the polarity of the power supply source (23) of the Peltier cell (18) and finally to choose to heat or to cool the air of the area (5) to be treated.

The operating means (28) are borne by the lower face (15) of the casing (6) which houses the thermal treatment device (2), so as to be easily accessible to a passenger of the vehicle and so as to be placed in the vicinity of the electronic card (27) bearing the control means (25), with the result that the wiring for said device (2) is reduced. The operating means (28) are additionally able to be activated by remote-control operating means, of the infrared or high-frequency type.

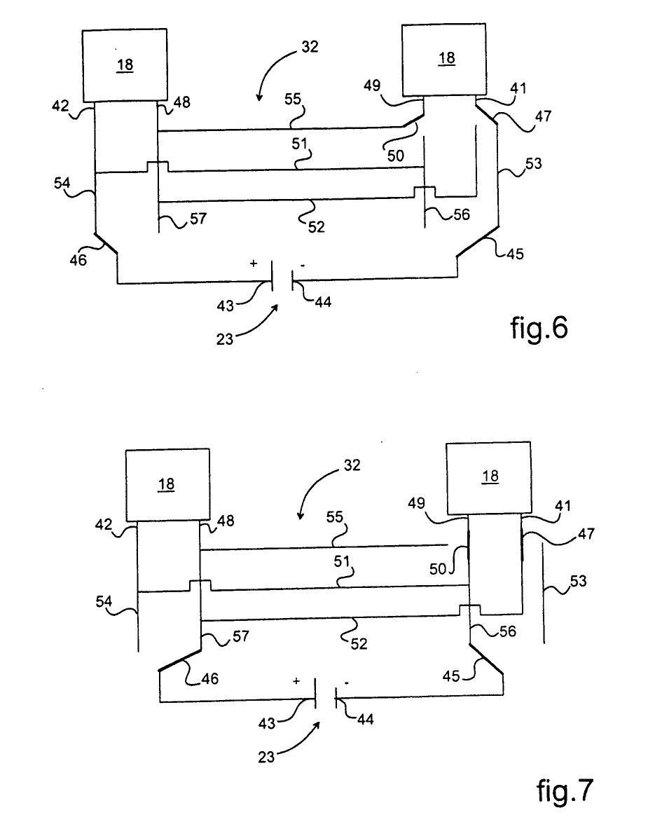

In FIG. 6 and FIG. 7, and in the case where there are a plurality of Peltier cells (18), the selection button (31) is an operating element for selecting between a first, series wiring (32) of the Peltier cells (18), illustrated in FIG. 6, and a second, parallel wiring (33) of these cells (18), illustrated in FIG. 7. Thus, to optimize cooling of the air expelled toward the area (5) to be treated, particularly in summer mode, it is preferable to mount the Peltier cells (18) in series, whereas to optimize heating of this same air, particularly in winter mode, it is preferable to mount these cells (18) in parallel.

More specifically in FIG. 6, first terminals (41, 42) of the Peltier cells (18) are respectively connected to the positive (43) and negative (44) terminals of the electrical power source of the vehicle (23). Main contactors (45, 46) or the like are interposed over these links (53, 54) in such a way as to allow the current to flow. An additional contactor (47) is placed on one of these links, allowing the current to flow. Second terminals (48, 49) of the Peltier cells (18) are interconnected by a secondary link (55), a secondary contactor (50) or the like being interposed over this secondary link (55) in such a way as to allow the current to flow. Additional branches (51, 52) respectively interconnect the first terminals (41, 42) with the second terminals of the Peltier cells (18), the flow of current being interrupted across these additional branches.

In FIG. 7, the main contactors (45, 46) are switched to reverse the power supply polarity at the terminals (41, 42, 48, 49) of the Peltier cells (18). The current flows across the links (56, 57) respectively connecting the positive (43) and negative (44) terminals of the power supply source (23) with the second terminals (48, 49) of the Peltier cells. The additional contactor (47) is switched to interrupt the power supply of the corresponding Peltier cell (18) at its first terminal (41) and to allow the current to flow across the corresponding additional branch (52), in contact with the link (57) connecting the positive terminal (43) of the power supply source (23) with the corresponding Peltier cell (18). The secondary contactor (50) is switched to interrupt the current flow across the secondary link (55) and to allow the current to flow, on the one hand, across the link (56) between the corresponding Peltier cell (18) and the negative terminal (44) of the power supply source (23) and, on the other hand, across the corresponding additional branch (51) interconnecting the second terminal (49) of one of the Peltier cells (18) with the first terminal (42) of the other Peltier cell, the additional branch being in contact with the link (56) connecting the negative terminal (44) to the corresponding Peltier cell (18).

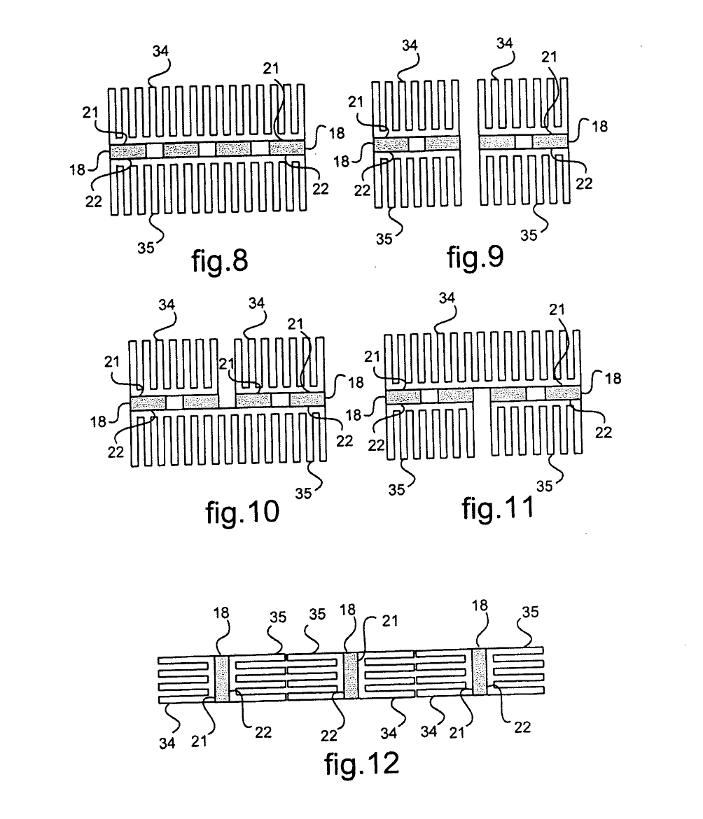

In FIG. 8 to FIG. 12, the Peltier cells (18) are equipped with heat sinks (34, 35) at each of their faces (21, 22). The heat sinks (34, 35) consist for example of a thermally conductive material folded over on itself. This material is for example aluminum, graphite, silver or gold and has a low thermal resistance of around 0.01 to 0.2 K/W at the surface. According to another embodiment, the heat sinks (34, 35) may consist of an extruded material in order to reduce the manufacturing costs and obtain complex shapes. In FIG. 8 to FIG. 11, the Peltier cells (18) are arranged in the enclosure (38) such that the faces having identical thermal behavior are substantially placed in one and the same plane. In FIG. 8, one and the same first heat sink (34) abuts all the endothermic faces (21) of the Peltier cells (18), while a second heat sink (35) abuts all the exothermic faces (22) of the Peltier cells (18). In FIG. 9, the heat cells (34, 35) abut the endothermic (21) and exothermic (22) faces respectively of adjacent Peltier cells (18). In FIG. 10, the exothermic faces (22) of two adjacent Peltier cells (18) are covered by one and the same first heat sink (34), while the endothermic faces (21) of all the Peltier cells (18) are covered by a single heat sink (35). FIG. 11 illustrates a variant which is the reverse of that represented in FIG. 10, from one of the exothermic (22) and endothermic (21) faces to the other. In FIG. 12, the Peltier cells (18) are arranged in the enclosure (38) such that the faces having identical thermal behavior are substantially placed opposite one another, each of the faces (21, 22) being equipped with a respective heat sink (34, 35).

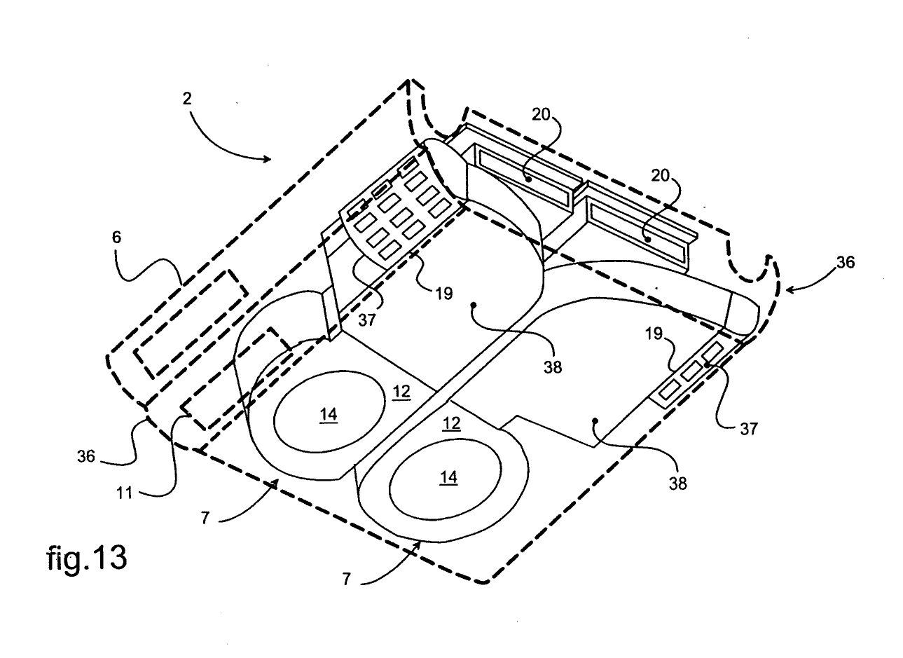

In FIG. 13, the module (2) comprises two thermal treatment devices (7) intended to treat two respective areas (5) of the vehicle cabin (1), such as a right-hand rear area and a left-hand rear area. The air intake orifice (11) is formed through a lateral wall (36) of the casing (6), which may equally be a right, left, front or rear area of this casing (6), or even through more than one of these walls (36). According to other embodiments (not shown), the intake orifice may be formed in a lower wall or an upper wall of the casing. The first air outlet orifices (19), which are intended to discharge the air toward the area (5) to be treated, are also formed in said lateral wall (36) of the casing (6). According to another embodiment (not shown), the first air outlet orifices may be formed in the lower wall of the casing. The first air outlet orifices (19) are equipped with air vents (37), such as those of the type which are provided with inclinable fins to direct the flow of air coming out through the orifices (19). The air vents (37) are, for example, of the type which are configured as a cylinder and are able to pivot through 360° about their axis. According to another variant embodiment (not shown), the air vents (37) are, for example, alternatively formed in closure flaps of the first outlet orifices (19), these flaps being mounted in a tilting manner on the casing (6).

The second air outlet orifices (20) are formed through a lateral wall (36) of the casing (6) or alternatively, according to variants (not shown), through an upper wall of the casing or through a rear wall of the casing and are at the same time disposed in such a way as not to disturb the thermal comfort of the passengers.

1. A module for ventilating, beating and/or air-conditioning an area (5) of a vehicle cabin (1) that is to be thermally treated, comprising at least one thermal treatment device (7) which includes an enclosure (38) in contact with at least one impeller (12) and is designed to extract air from the cabin (1) and circulate this air inside the enclosure (38) and then expel the air toward the area (5) to be treated, wherein at least one Peltier-type cell (18) is housed inside the enclosure (38), the latter comprising a first duct (16) for circulating the admitted air along a first face (21) of the Peltier cell (18), prior to its being expelled toward the area (5) to be treated, and a second duct (17) for circulating the admitted air along a second face (22) of the Peltier cell (18), prior to its being expelled from the area (5) to be treated.

2. The module as claimed in claim 1, wherein said device (7) is equipped with means (25) for controlling the temperature of the Peltier cell (18) and the air delivery rate of the impeller (12).

3. The module as claimed in claim 2, wherein the control means (25) are borne by an electronic card (27).

4. The module as claimed in claim 3, wherein the electronic card (27) is placed inside said first duct (16).

5. The module as claimed in claim 3, wherein the electronic card (27) is placed inside said second duct (17).

6. The module as claimed in any one of the preceding claims, wherein the device (7) is housed inside a casing (6) equipped with means for fastening it to a structural element (3) of the cabin (1).

7. The module as claimed in claim 6, wherein the casing (6) houses the impeller (12) in a first chamber (10) in communication with the enclosure (38) formed by a second chamber of the casing (6).

8. The module as claimed in claim 7, wherein the casing (6) comprises at least one air intake orifice (11) in contact with the air inlet (14) of the impeller (12) and at least two air outlet orifices (19, 20) for expelling air from the casing (6), a first air outlet orifice (19) of which is in communication with the first duct (16) and a second air outlet orifice (20) of which is in communication with the second duct (17).

9-17. (canceled)

18. The module as claimed in claim 2, characterized in that the activation of the control means (25) is placed under the control of operating means (28).

19. The module as claimed in claim 18, wherein the operating means (28) are borne by the casing (6).

20. The module as claimed in claim 19, wherein the operating means (28) are borne by a lower wall (15) of the casing (6), this wall likewise bearing the electronic card (27).

21. The module as claimed in claim 18, wherein the operating means (28) comprise remote-control operating means.

22. The module as claimed in claim 18, wherein the operating means (28) comprise means (31) for selecting the thermal behavior of the faces (21, 22) of the Peltier cell (18).

23. The module as claimed in claim 22, wherein the selection means (31) are associated with means for reversing the polarity of at least one electrical power supply source (23) of the Peltier cell (18).

24-29. (canceled)
